(19) United States
(12) Patent Application Publication
(10) Pub. No.: US 2018/0155939 A1
(43) Pub. Date: Jun. 7, 2018

(54) RAPID ASSEMBLE COUPLER

(71) Applicant: Paul ALDRIDGE, Warwick (GB)

(72) Inventor: Paul ALDRIDGE, Warwick (GB)

(21) Appl. No.: 15/571,718

(22) PCT Filed: May 5, 2016
(86) PCT No.: PCT/GB2016/051287

§ 371 Date: Nov. 3, 2017

(30) Foreign Application Priority Data
May 5, 2015 (GB) 1507660.7
Apr. 29, 2016 (GB) 1607586.3

(51) Int. Cl. E04G 7/08; E04H 17/14; F16B 7/04; F16B 2/14

(52) U.S. Cl. CPC E04G 7/08; F16B 2/14; F16B 7/0433; E04H 17/14

(57) ABSTRACT

A rapid assemble coupler for coupling together at least two non-overlapping elements, the coupler comprising a first member and an opposing second member; a rod passing through the first member and connected, in use, to the second member; and a lever-operated cam pivotably attached to the rod; wherein, in use, rotation of the cam causes the first member to be translated towards the second member, thereby clamping each element between the first and second member.

### FIELD OF THE INVENTION

The invention relates to a rapid assemble coupler for coupling together non-overlapping elements, such as temporary fence panels.

### BACKGROUND

Temporary fences have become a common sight on construction sites and at organised events. They can come in various types and sizes, depending on whether they are to be used as a physical barrier, or for crowd control. Generally, however, a temporary fence comprises a series of individual fence panels connected together.

In a common form of temporary fence, such as a common form of temporary mesh fence panel, adjacent fence panels are connected by a coupler. Typically, each panel comprises an outer frame, including vertical uprights. One upright from each of the adjacent panels is held in the coupler to construct the temporary fence.

Currently used couplers comprise two members connected by a nut and bolt. To couple two uprights together, the nut must be tightened so that the two uprights are clamped between the first member and the second member. This requires tools—typically a heavyweight spanner—and is time consuming. Connecting a large number of panels together therefore requires a lot of time, and a lot of manpower. A coupler that can be fastened without tools, and without requiring a lot of time, is therefore needed.

Crowd control barriers typically use an alternative form of temporary fence, comprising a series of interlocking fence panels. Hooks on one side of a first panel are inserted into loops on a second panel, which is similarly connected to a third panel, and so on. This design of temporary fence is also time consuming to assemble, especially when hooks have become damaged.

Not only are both types of fence time consuming to connect together, they are also difficult to take apart. Nut-and-bolt-style couplers require a spanner to unfasten the bolt in order to disconnect two fence panels. In interlocking crowd control barriers, only the final panel in the series can be removed, and so a large number of panels may have to be disconnected to permit access between two panels further along the series. The time consuming process of disconnecting two fence panels is a nuisance in normal use. In an emergency situation, it can be dangerous. For example, emergency medical access may be required through a particular part of the fence. There is therefore a need for a temporary fence that can be quickly and easily disconnected at any point without requiring tools.

It is an object of the invention to address on or more of the above-mentioned problems.

### SUMMARY OF THE INVENTION

In accordance with a first aspect of the invention there is provided a rapid assemble coupler for coupling together at least two non-overlapping elements, the coupler comprising a first member and an opposing second member; a rod passing through the first member and connected, in use, to the second member; and a lever-operated cam pivotably attached to the rod; wherein, in use, rotation of the cam causes the first member to be translated towards the second member, thereby clamping each element between the first and second member.

A rapid assemble coupler according to the invention may have the advantage of being easily fastened, without the need for tools. It may also be quickly released, permitting, for example, rapid access between two temporary fence panels.

The cam may for example be a lever-operated cam. In particular, the cam may be integrated into the lever. For example, the lever may be used to rotate the cam by an angle less than 360°. In alternative embodiments, the cam may comprise a handle for rotating the cam, such as a handle extending axially from the cam.

The cam may comprise an eccentric disc, such that translation of the first member towards the second member requires a less than 360° rotation of the cam.

Alternatively the eccentricity of the cam may be extended axially, for example the cam may comprise an axially extended spiral whose diameter increases with axial position, for example such that translation of the first member towards the second member requires a greater than 360° rotation of the cam. In such embodiments, rotation and translation of the cam may be necessary to translate the first member towards the second member. For example, the cam may comprise a threaded extension adapted to engage with a nut attached to the first member. Rotation of the cam, for example using a handle extending axially from the cam, may cause the threaded extension to engage with the nut and so translate the cam, thus translating the first member towards the second member. In particular, translation of the cam may be in a direction that is substantially perpendicular to the direction of translation of the first member towards the second member.

According to a second aspect of the invention there is provided a rapid assemble coupler for coupling together at least two non-overlapping elements, the coupler comprising: a first member and an opposing second member; a rod passing through the first member, the rod comprising a first end connected in use to the second member and a second end comprising a stopper; and a wedge at least partially located between the first member and the stopper; wherein, in use, translation of the wedge in a first direction causes the first member to be translated towards the second member in a second direction that is substantially perpendicular to the first direction, thereby clamping each element between the first member and the second member.

In some embodiments, the wedge may comprise a slot, wherein the rod passes through the slot.

For example, in use, the wedge may be translated by manually pushing the wedge, or by hammering the wedge.

Such a coupler may be rapidly fastened and easily released, similarly to the coupler of the first aspect.

The following embodiments may apply equally to the first or second aspects of the invention.

In some embodiments of the coupler, the rod may pass, when in use, between the two elements. This may provide an even application of the clamping force on the two elements. At least one surface of the first member and/or the second member may be adapted to conform to the shape of the at least two elements. This may have the advantage of allowing the coupler to better fit the elements, and/or spreading the clamping force across a greater surface area of the elements.

In some embodiments, the rod may have a threaded portion passing through the second member, wherein rotation of the rod causes the second member to be translated axially relative to the rod. This may allow for easier installation of the coupler. The first member and second member can be initially spaced widely apart, allowing the coupler to be easily slid down elongate elements, such as fence uprights, to the desired location of the coupler. Rotating the rod will then bring the second member towards the first member, to tighten the coupler before fastening the coupler with the cam and lever.

These embodiments may further comprise a means operable to substantially prevent rotation of the rod in a direction that would cause the second member to be translated away from the first member. This is advantageous in preventing the loosening of the fastened coupler. The means may be a part extending outwardly from the outer surface of the first member, configured to prevent rotation in a particular direction of the lever-operated cam when the lever-operated cam is in the closed position. Alternatively, the means may comprise a nut or a saddle.

In an embodiment, the coupler may comprise a locking means operable to lock the lever-operated cam in the closed position. Accordingly, security of the coupler may be improved, since a user would need to unlock the locking means in order to operate the lever to open the coupler.

The rod may be connected to the second member by means of a fastener that is external to the second member, for example a bolt. The fastener may be permanently attached to the second member. Alternatively, the rod may be directly attached to the second member, for example by an adhesive, or, in embodiments where the rod is threaded, by a threaded hole on the second member. The rod may comprise a wider end part to prevent the second member being unscrewed from the rod.

In some embodiments, the coupler may further comprise at least one resilient means between the first member and the second member, configured to oppose translation of the first member towards the second member. A resilient means may be useful for keeping the members apart when the coupler is not fastened, and may provide an easier, smoother action when fastening the coupler with the cam and lever.

The resilient means may comprise a resiliently deformable member or a spring, e.g. a metal or plastic spring. In an embodiment, the rod may pass through the spring.

The lever-operated cam may be detachable from the rod. Any of the first member, second member, cam, lever and wedge may be formed substantially of a plastic (i.e. polymeric) material, e.g. high density plastic. This may have the advantage of allowing the coupler to be easily branded to discourage theft of loaned parts, and/or of being coloured, e.g. to represent a purpose. For example, one or more components of a coupler intended for use at a specific location, e.g. on an emergency access route, may be distinctively coloured, e.g. red or green, and/or patterned and/or may carry text, symbols or other indicia signifying or associated with the specific location. Additionally, a plastic material such as high density plastic may be more easily recyclable than the metal of a traditional coupler.

Some embodiments of the coupler according to the first aspect of the invention may further comprise a second rod passing through the first member and connected in use to the second member, and a second lever-operated cam pivotably attached to the second rod; wherein, in use, rotation of the second cam causes the first member to be translated towards the second member, thereby clamping the elements between the first and second member. In these embodiments, the two sets of rods and cams may increase and/or better distribute the available clamping force, potentially providing a more secure coupler.

In an alternative embodiment of the first aspect, the coupler may comprise a second rod passing through the second member and connected in use to the first member; and a second lever-operated cam pivotably attached to the second rod; wherein, in use, rotation of the second cam causes the second member to be translated towards the first member, thereby clamping the elements between the first and second member.

Some embodiments of the coupler according to the second aspect of the invention may further comprising a second rod passing through the first member, the rod comprising a first end connected in use to the second member and a second end comprising a second stopper; and a second wedge at least partially located between the second member and the second stopper; wherein, in use, translation of the second wedge in a third direction causes the second member to be translated towards the first member in a fourth direction that is substantially perpendicular to the third direction, thereby clamping each element between the first and second member.

In embodiments comprising two rods, the elements may be located, in use, between the first and the second rod.

In an embodiment, the lever(s) or wedge(s) may not extend beyond an end of the first and/or second member when the lever-operated cam(s), or wedges(s) has/have been operated to couple, e.g. clamp, the elements between the first and second members. Hence, it may be relatively difficult to access the lever or wedge from the opposite side of the coupler, thereby improving the security of a fence or barrier, in which the coupler is used to couple, e.g. clamp, elements together.

In some embodiments, the coupler may be operable to be attached to a backstay. A backstay may be used to provide additional support to the elements. For example, when the elements are uprights of adjacent fence panels, a backstay may be used to increase the stability of the fence, especially on uneven ground or in windy conditions.

According to a third aspect of the invention there is provided a fence comprising: a rapid assemble coupler according to the first or second aspects of the invention; and at least two fence panels, each fence panel comprising one of the said elements; wherein the rapid assemble coupler couples, e.g. clamps, the elements of the two fence panels together. Using the rapid assemble coupler to hold the panels together has the advantages discussed above of increasing the ease with which the fence may be constructed, and/or disconnected.

According to a fourth aspect of the invention there is provided a scaffold pole assembly comprising at least two scaffold poles; and a rapid assemble coupler according to the first or second aspects of the invention; wherein the rapid assemble coupler couples, e.g. clamps, two scaffold poles together. The rapid assemble coupler may be particularly useful in connecting poles used for non-structural purposes in scaffolding, such as handrails. Use of the rapid assemble coupler may speed up installation of the scaffolding, and/or may reduce the manpower required to install it.

According to a fifth aspect of the invention there is provided a method of coupling, e.g. clamping, two non-overlapping elements together using a rapid assemble mechanism, the method comprising: providing a first element and a second element; providing a rapid assemble coupler, the coupler comprising a first member and an opposing second member, a rod passing through the first member and connected, in use, to the second member, and a lever-operated cam pivotably attached to the rod; placing the rapid assemble coupler around the first and second elements such that the elements are located between the first and second members of the coupler, and rotating the cam of the coupler, thereby causing the first member to be translated towards the second member, and so clamping each element between the first and second member.

In some embodiments of the method, the rod may have a threaded portion passing through the second member and the method may further comprise tightening the coupler by rotating the rod, causing the second member to be translated axially relative to the rod.

In some embodiments, the method may further comprise passing the second member between the elements whilst the second member is rotated relative to the first member; and rotating the second member to substantially match the orientation of the first member.

In some embodiments, two or more rapid assemble couplers may be used to coupler the elements together.

According to a sixth aspect of the invention there is provided a rapid assemble coupler for coupling together at least two non-overlapping elements, the coupler comprising: a first member and an opposing second member; and a rod pivotably connected to the second member, the rod comprising one or more, e.g. a plurality of, notches adapted to engage with a reciprocal notch on the first member. In an embodiment, the first member may comprise more than one reciprocal notch.

In some embodiments, the coupler may further comprise at least one resilient biasing means between the first member and the second member, the or each resilient biasing means being configured to oppose translation of the first member towards the second member.

In use, such a coupler may be placed around two or more elements, and the first member and second member pressed together so that they clamp the elements between them. The rod may be pivoted towards the first member, and one of the notches of the rod engaged with the reciprocal notch on the first member, in order to lock the first member and second member in place around the elements.

For example, the first member may comprise a hole, and the rod may pass through the hole. The reciprocal notch of the first member may be located at an edge of the hole in the first member.

Such a coupler may be rapidly fastened and easily released, similarly to the coupler of the first aspect.

According to a seventh aspect of the invention there is provided a rapid assemble coupler for coupling together at least two non-overlapping elements, the coupler comprising: a first member and an opposing second member; a rod passing through the first member and connected in use to the second member; at least one resilient biasing means between the first member and the second member, the or each resilient biasing means being configured to oppose translation of the first member towards the second member; and a fastening element adapted to translate along the rod and to limit translation of the first member away from the second member.

For example, the rod may comprise a thread, and the fastening element may be adapted to engage with the thread on the rod. In particular embodiments, the fastening element may be a nut or a wingnut. A wingnut may be particularly preferable, as it may allow the coupler to be fastened by hand.

Such a coupler may be rapidly fastened and easily released, similarly to the coupler of the first aspect.

According to an eighth aspect of the invention there is provided a rapid assemble coupler for coupling together at least two non-overlapping elements, the coupler comprising: a first member and an opposing second member, the first member comprising a threaded fastener; at least one resilient biasing means between the first member and the second member, the or each resilient biasing means being configured to oppose translation of the first member towards the second member; and a rod passing through the first member and connected in use to the second member; wherein the rod comprises a threaded portion adapted to engage with the threaded fastener such that relative rotation of the rod and the fastener causes the first member to be translated towards the second member, thereby clamping each element between the first member and second member.

The threaded fastener may for example be a nut attached to the first member. Alternatively the threaded fastener may be integrated into the first member. For example, the first member may comprise a threaded hole through which the rod passes, and which engages with the threaded portion of the rod.

For example, one end of the rod may comprise a slotted screw head, so that a screwdriver may be used to rotate the rod and thus fasten the clamp.

Such a coupler may be rapidly fastened and easily released.

Any of the embodiments described in relation to the first and second aspects of the invention may equally be applied to the couplers of the sixth, seventh, and/or eighth aspects.

A further aspect of the invention provides the use of a coupler according to any one of the first, second, sixth, seventh and/or eighth aspects of the invention to couple together at least two non-overlapping elements. For example, the non-overlapping elements may comprise: components for a fence, barrier or handrail; or scaffolding poles.

In contrast to the devices currently used for fixing in place fence panels at events, e.g. sporting or musical or other entertainment events, or on construction sites, the rapid assemble couplers of the present invention may be relatively quick, effective and easy to use.

Thus, many significant advantages may be realised. To take one example, a large-scale outdoor event, e.g. a sporting event or entertainment event or festival, may require a large amount of temporary fencing to be installed at the event site prior to the event and then dismantled and removed from the event site after the event has taken place. This temporary fencing may mark the boundary of the event site and/or may be used to define enclosures and access routes within the event site. Such temporary fencing is made up of many panels coupled together and may be many hundreds of metres in length or more. Thus, by providing a coupler that is quicker and easier to use, this invention could provide significant savings in terms of time, cost and/or manpower in installing and dismantling temporary fencing for the event.

Furthermore, since the coupler may be released quickly and without requiring the use of specialist tools, quicker, safer access and/or exit routes may be provided at an event site. This may be especially beneficial in the case of an emergency.

Often the principal function of temporary fencing is to guide attendees at an event, e.g. to indicate where an attendee should and should not go (e.g. to indicate to spectators at a sporting event that they should not encroach on to areas reserved for athletes). Temporary fencing typically cannot be 100% secure, and typically is not intended to be. A determined intruder would be able to get through most temporary fencing and, in most instances, additional security is provided by stewards whose duties include looking out for, and then dealing with, intruders.

Use of a rapid assemble coupler according to the invention may be advantageous in many applications. For instance, the rapid assemble couplers of the invention may be used to connect panels in a fence or barrier, e.g. a temporary fence or barrier, a crowd control barrier or pedestrian barrier. The rapid assemble couplers of the invention may also be used to connect elongate members, e.g. poles such as scaffold poles, for non-structural purposes, e.g. handrails or the like.

The rapid assemble couplers of the invention may also have utility in a domestic setting, e.g. in the house or garden.

### DETAILED DESCRIPTION

The invention is described in further detail below by way of example and with reference to the accompanying drawings, in which:

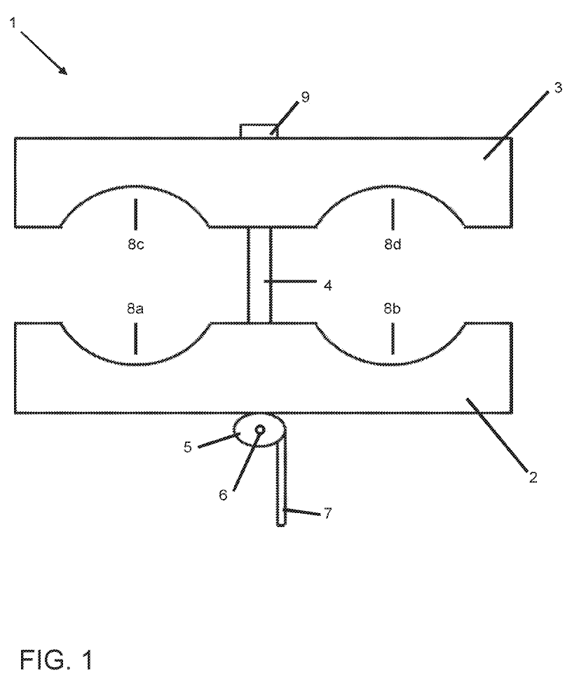

FIG. 1 is a schematic representation of a coupler according to one embodiment of the invention;

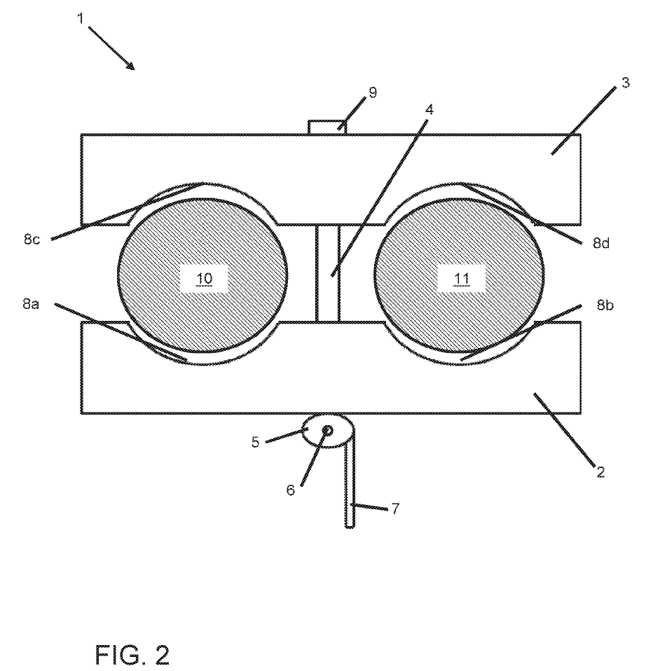

FIG. 2 is a schematic representation of the coupler of FIG. 1 in use;

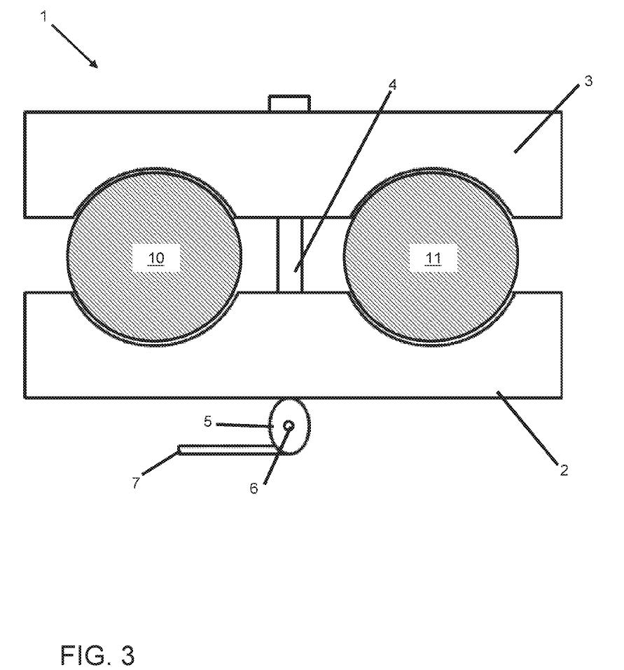

FIG. 3 is a schematic representation of the coupler of FIG. 1, in which the coupler is in a closed configuration, thereby coupling together two non-overlapping elements;

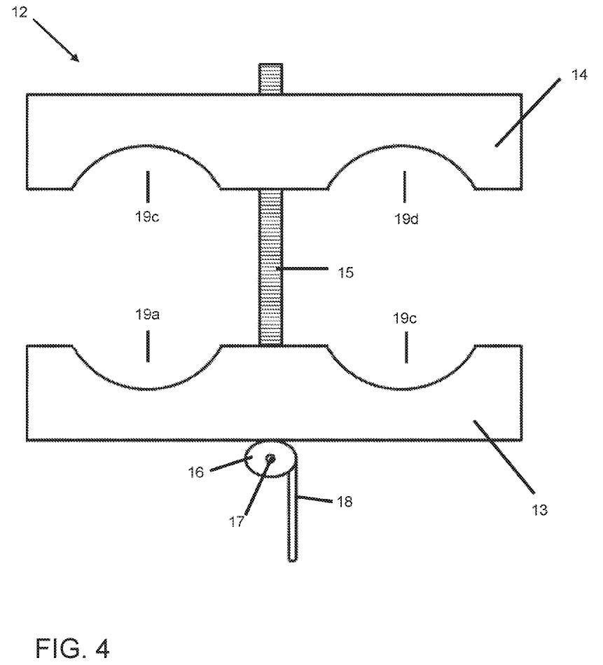

FIG. 4 is a schematic representation of an alternative embodiment of a coupler according to the invention;

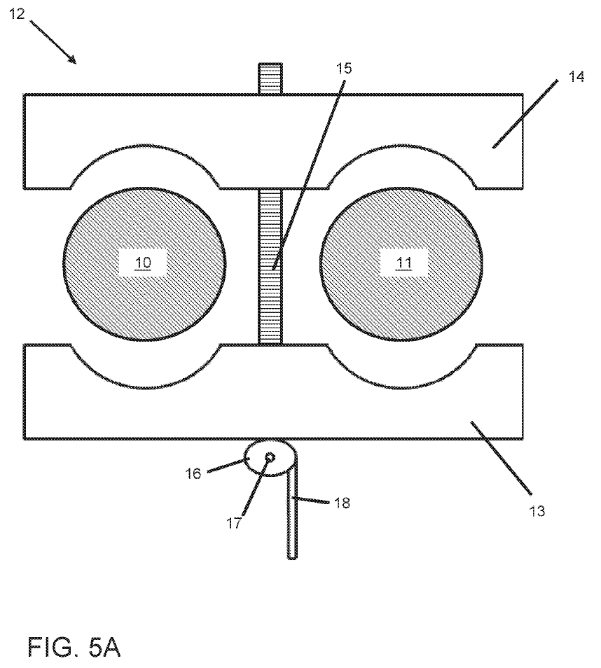

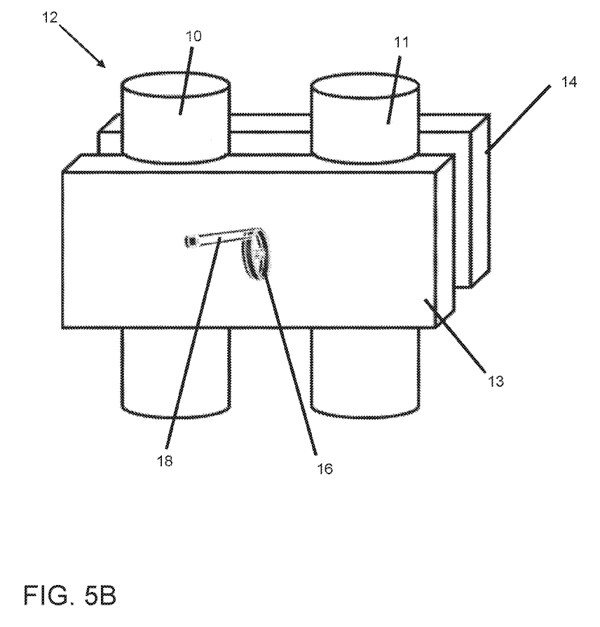

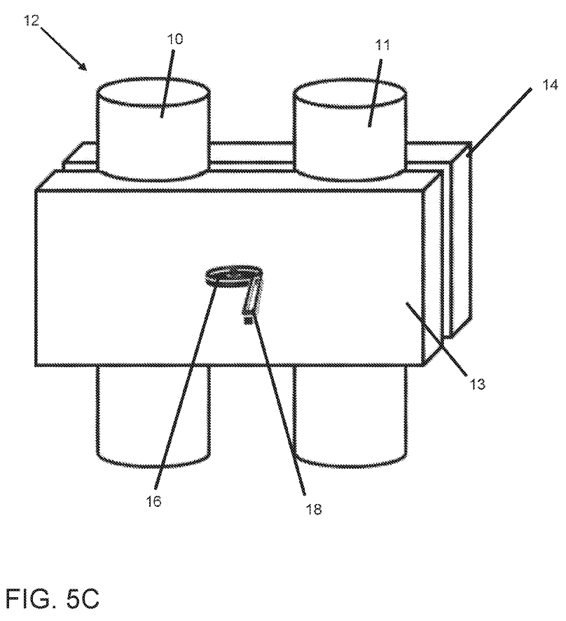

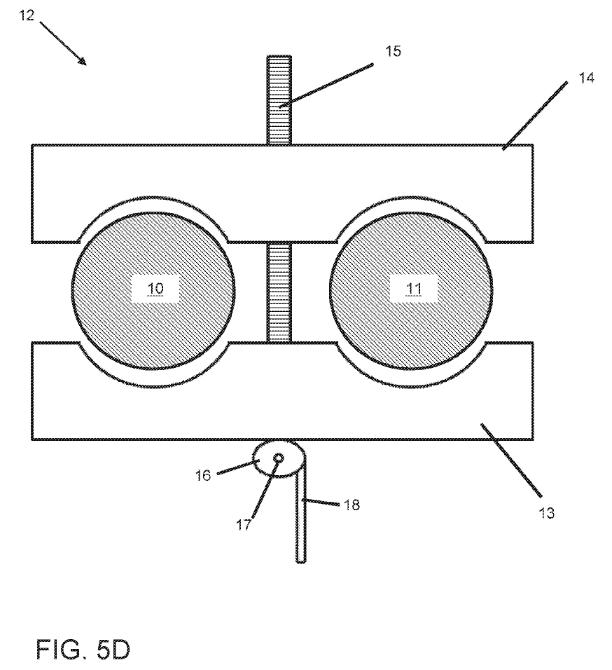

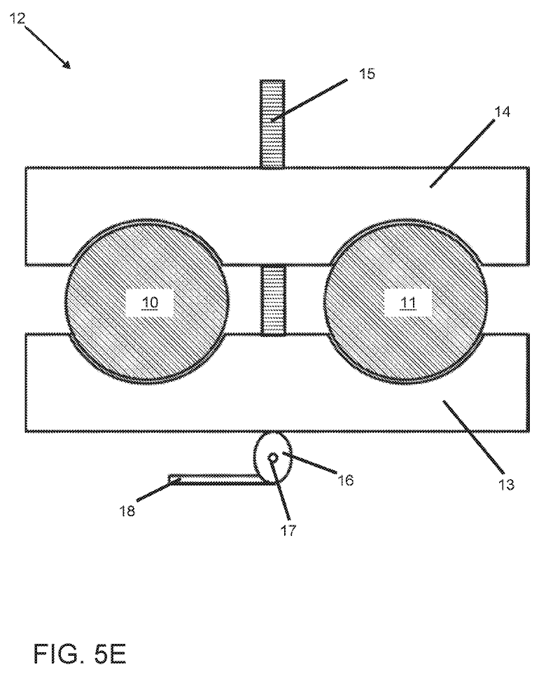

FIG. 5A is a schematic representation of the coupler of FIG. 4 in use;

FIG. 5B is a schematic representation of an alternative view of the coupler of FIG. 4 in use;

FIG. 5C is a schematic representation of the coupler of FIG. 4, in use, with the rod rotated;

FIG. 5D is a schematic representation of an alternative view of the coupler of FIG. 4, in use, with the rod rotated;

FIG. 5E is a schematic representation of the coupler of FIG. 4 in a closed configuration, thereby coupling together two non-overlapping elements;

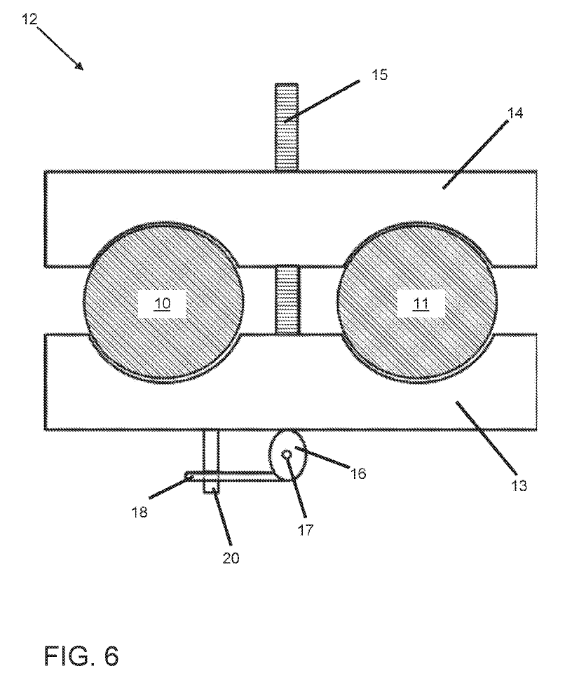

FIG. 6 is a schematic representation of another embodiment of a coupler according to the invention, the coupler further comprising a means to prevent rotation of the rod;

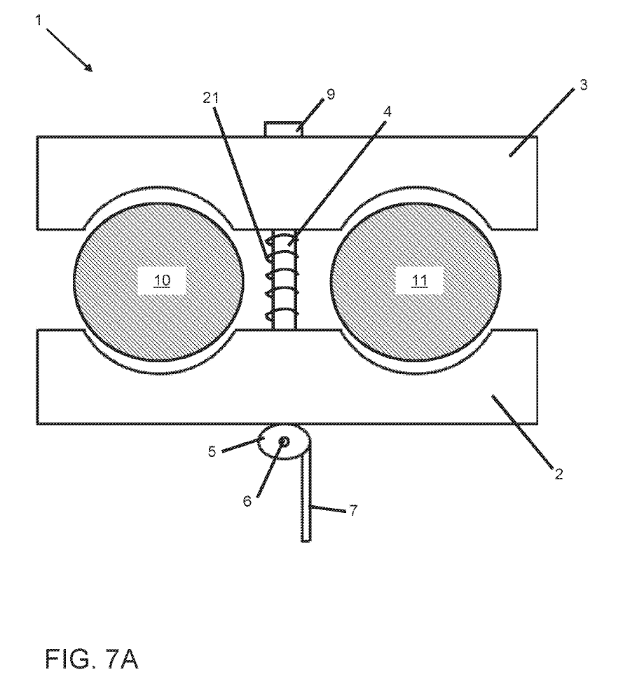

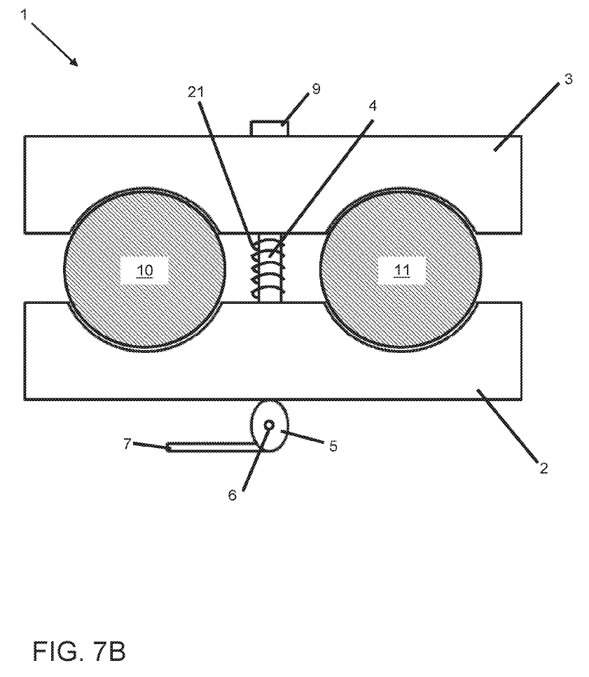

FIG. 7A is a schematic representation of another embodiment of a coupler according to the invention, the coupler including a resilient means with the coupler shown in an open position;

FIG. 7B is a schematic representation of the coupler of FIG. 7A in a closed position;

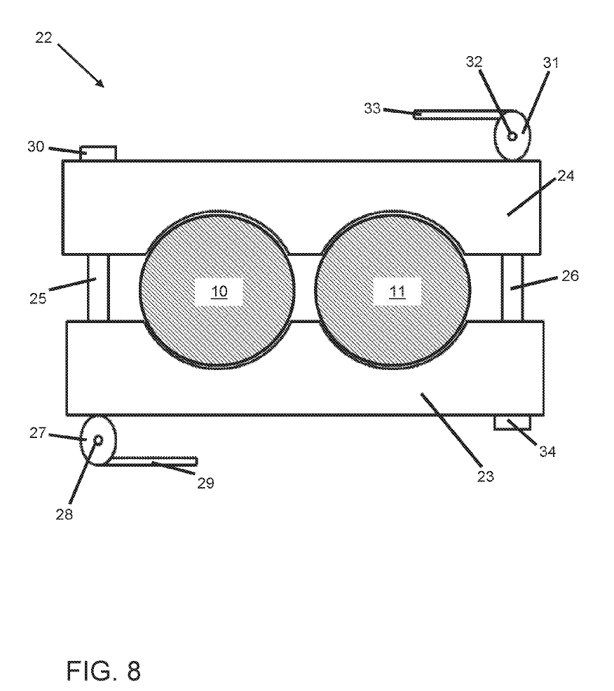

FIG. 8 is a schematic representation of another embodiment of a coupler according to the invention, the coupler including two rods and cams;

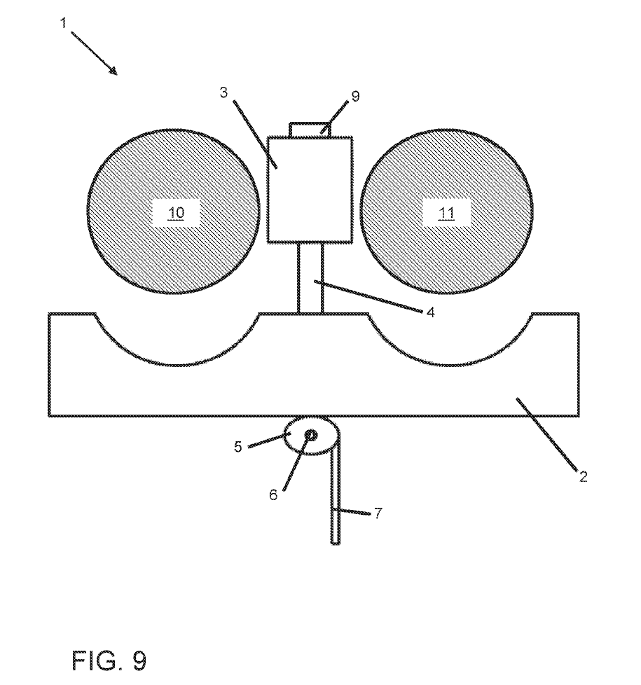

FIG. 9 is a schematic representation of a method of installing a coupler according to an embodiment of the invention;

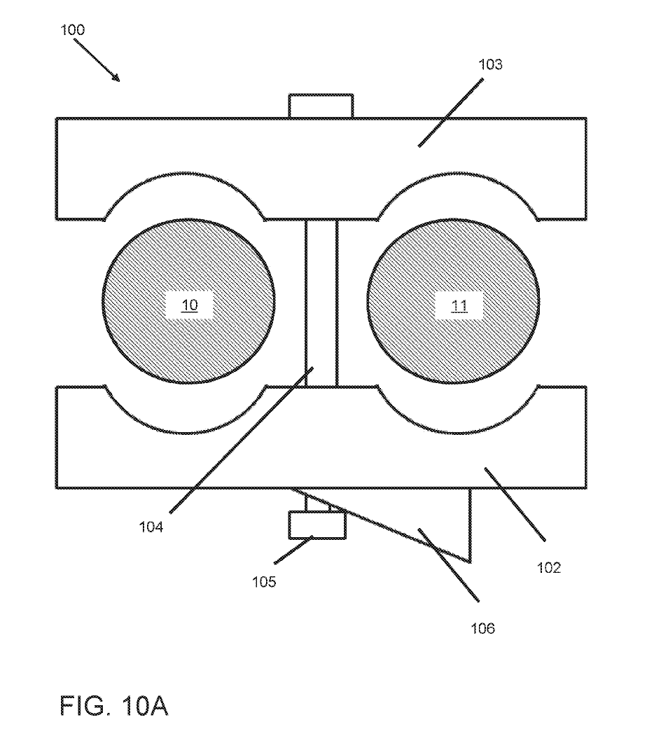

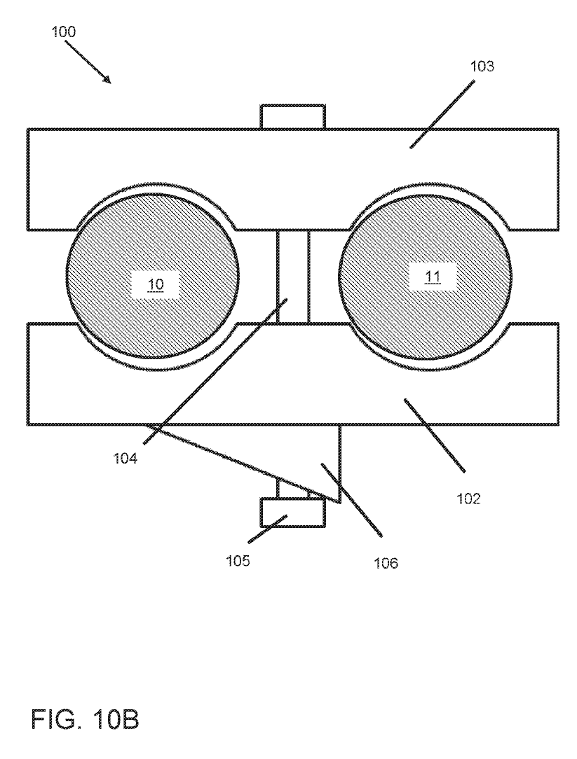

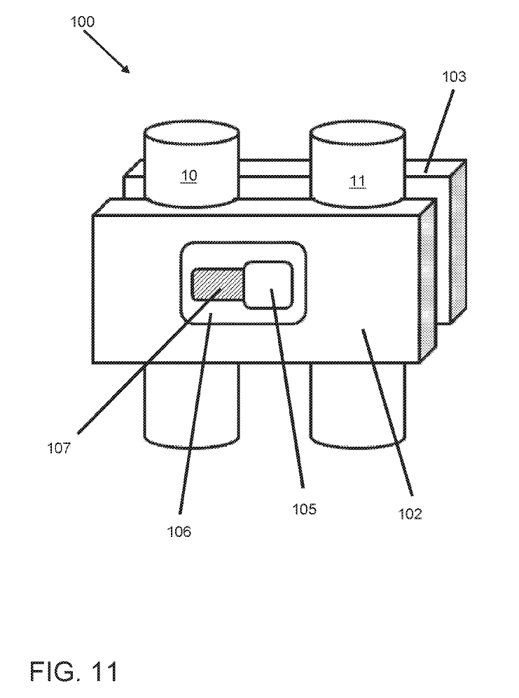

FIGS. 10A, 10B and 11 illustrate another example embodiment of a coupler for coupling together two non-overlapping elements;

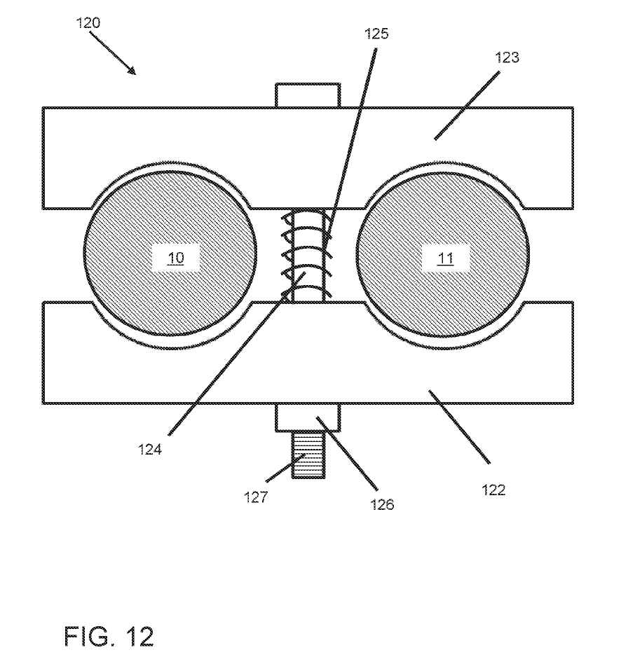

FIG. 12 illustrates another example embodiment of a coupler for coupling together two non-overlapping elements; and

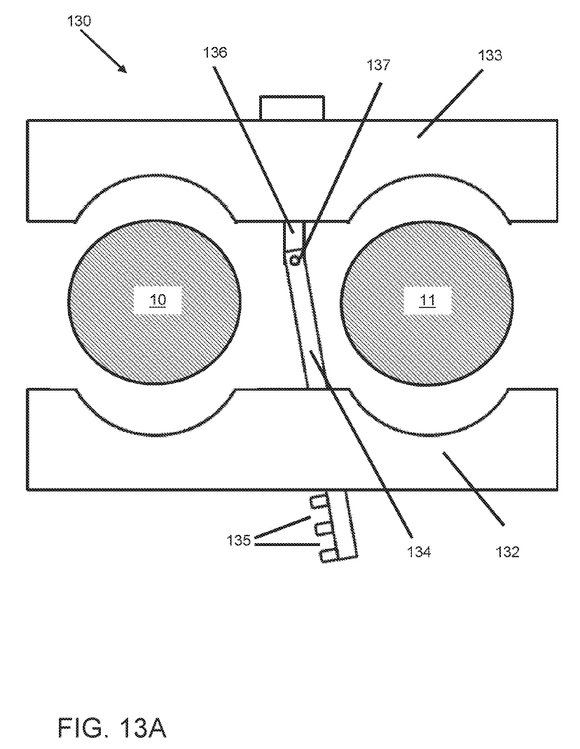

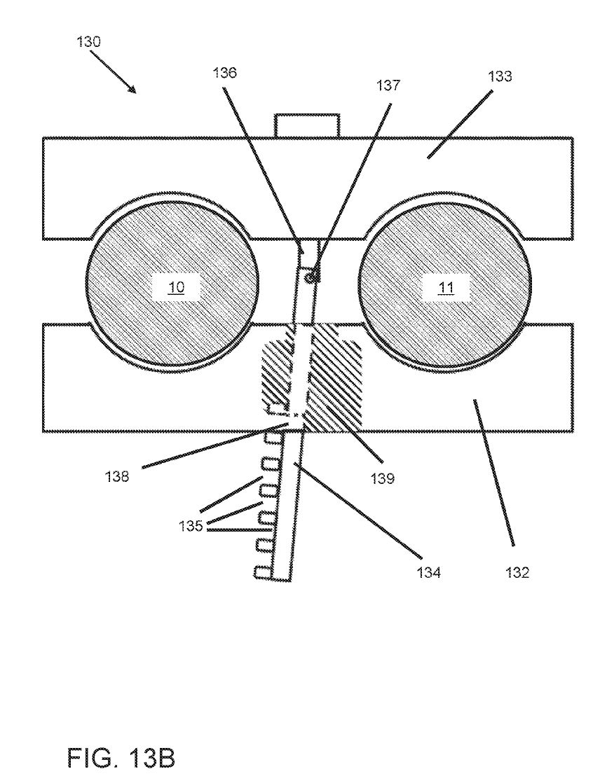

FIGS. 13A and 13B illustrate another example embodiment of a coupler for coupling together two non-overlapping elements.

FIG. 1 illustrates an exemplary coupler 1 for coupling together two non-overlapping elements (not shown). The coupler 1 comprises a first member 2 and a second member 3. A rod 4 passes through the first member 2, and is connected to the second member 3. A cam 5 is rotatably attached to the rod 4 about the pivot point 6, so that cam 5 can rotate about an axis that is radial to the rod 4. For example, cam 5 and rod 4 may be connected by a bolt which passes through both cam 5 and radially through rod 4. A washer (not shown) may be located between the cam 5 and the first member 2.

The cam 5 may be rotated about pivot point 6 by pushing the lever 7. Cam 5 may be integrated into lever 7, or the cam 5 and the lever 7 may be separate parts.

In the illustrated embodiment, the first member 2 and second member 3 are adapted to conform to the outer surface(s) of the non-overlapping elements with which coupler 1 is designed to be used. Portions 8a and 8b of the surface of the first member 2, and portions 8c and 8d of the surface of the second member 3 are adapted to fit around elements, as shown in FIG. 2.

It will be appreciated that the elements may have various cross-sectional shapes. For instance, the elements may be polygonal in cross-section, e.g. triangular, rectangular, square, trapezoidal, pentagonal, hexagonal, heptagonal, octagonal, nonagonal or decagonal. Alternatively, the elements may have an at least partially curved shape in cross-section, e.g. the elements may be elliptical or semi-circular in cross-section.

A surface of the first member and/or the second member may be adapted to receive at least partially the non-overlapping elements being coupled together.

For elements, e.g. poles and the like, of a circular cross-section, portions of the surfaces of the first and second members may be curved or arcuate to correspond to the circumference of the element.

Typically, the first member and the second member may each have the general form of a plate.

The rod 4 may be connected to the second member 3 directly, for example by an adhesive, or a threaded portion as described below. However, in the illustrated embodiment, a fastener 9 connects the rod 4 to the second member 3. All or part of the rod 4 may be threaded to permit connection. Fastener 9 may be, for example, a bolt attached to the end of rod 4. Fastener 9 is wider than a hole in the second member 3 through which rod 4 passes, so that when rod 4 is pulled towards the first member 2, second member 3 will also be pulled towards the first member 2. In some embodiments, the fastener 9 may be permanently attached to the second member 3, for example by an adhesive. However, this is not necessary for the coupler 1 to function.

FIG. 2 illustrates coupler 1 in place around two non-overlapping and adjacent elements 10 and 11. Elements 10 and 11 may be substantially parallel elongate elements, for example, the uprights of fence panels of a temporary fence, or scaffold poles.

Coupler 1 may be placed over the top of elements 10 and 11, and, where elements 10 and 11 are elongate, slid down elements 10 and 11 to the desired coupling position. Alternatively, the first member 2 or the second member 3 may be rotated relative to the other member, and passed between elements 10 and 11, as described below.

When coupler 1 is in the desired location, lever 7 is used to rotate the cam 5 about pivot point 6. In the illustrated embodiment, cam 5 is substantially oval or elliptically shaped, and must be rotated by approximately 90° from the open position to the closed position. Cam 5 may have flattened edges at the extremes of the oval or ellipse to provide stable open and closed positions. Alternatively, the cam may be otherwise configured to achieve a similar cam action.

FIG. 3 illustrates coupler 1 with the cam 5 in a closed position. Rotating cam 5 pulls rod 4 through the first member 2. As second member 3 is connected to the rod 4, second member 3 is also pulled towards the first member 2. Rotating the cam 5 therefore brings the first member 2 and second member 3 together such that the first member 2 and second member 3 may coupler elements 10 and 11 between them. To release elements 10 and 11, cam 5 may be rotated back to the open position shown in FIG. 2.

It should be noted that FIGS. 2 and 3 are not drawn to scale. In particular, spacing between the two members 2, 3 in FIG. 2 has been exaggerated to aid the clarity of the drawing.

FIG. 4 illustrates an alternative embodiment of a coupler 12 according to the invention. Coupler 12 comprises a first member 13 and a second member 14. A rod 15 passes through the first member 13, and is connected to the second member 14. A cam 16 is rotatably attached to the rod 15 about the pivot point 17, so that cam 16 can rotate about an axis that is radial to the rod 15. For example, cam 16 and rod 15 may be connected by a bolt which passes through both cam 16 and radially through rod 15.

The cam 16 may be rotated about pivot point 17 by pushing the lever 18. Cam 16 may be integrated into lever 18, or the cam 16 and the lever 18 may be separate parts.

In the illustrated embodiment, the first member 13 and second member 14 are adapted to conform to the outer surface(s) of the non-overlapping elements with which coupler 12 is designed to be used. Portions 19a and 19b of the surface of the first member 13, and portions 19c and 19d of the surface of the second member 14 are adapted to fit around elements, as shown in FIG. 5A, and are similar to portions 8a-8d previously discussed.

In this embodiment, rod 15 is at least partially threaded. The threaded portion of rod 15 is connected to the second member 14. In the illustrated embodiment, a threaded hole (not shown) in second member 14 engages with the threaded portion of the rod 15. In alternative embodiments, a fastener may engage with the threaded portion of the rod 15, and be connected to the second surface 14 similarly to the fastener 9 and second member 3 in the embodiment of FIG. 1.

In this embodiment, the threaded rod 15 engaging with the second member 14 may be rotated to produce a movement of the second member 14 axially along the rod 15. It may be necessary to hold second member 14 fixed to prevent rotation of second member 14 with rod 15.

This embodiment has the advantage of allowing the first member 13 and second member 14 to be initially wide apart to facilitate placement of the coupler 12. The coupler can be tightened by rotating the rod before finally using the cam 16 to coupler the members 10, 11 together, as demonstrated in FIGS. 5A-5E.

FIG. 5A shows the coupler 12 open and in position around elements 10 and 11. First member 13 and second member 14 are far apart from each other, to make passing the coupler 12 over elements 10 and 11 easier. When in location, first member 13 and second member 14 must be brought together to make clamping by rotation of the cam 16 possible.

Second member 14 may be translated towards the first member 13 by rotating the rod 15. Rod 15 may be rotated, for example, by rotating the cam 16 and lever 18 about an axis that is axial to the rod 15. Rotation of cam 16 in this direction necessarily rotates the rod 15, as relative rotation of the rod 15 and cam 16 is substantially only permitted around an axis that is radial to the rod 15.

FIG. 5B illustrates an alternative view of coupler 12 ready to be tightened. Rod 15 may be rotated by rotating cam 16 about an axis that is axial to the rod 15. For a right handed screw, rotating cam 16 in a clockwise direction will tighten coupler 12 by moving second member 14 axially along the rod 15, towards first member 13. This is illustrated in FIG. 5C.

Rod 15 may be rotated for example by approximately 90°, so that the second member 14 reaches the position shown in FIG. 5D. Here, first member 13 and second member 14 are sufficiently close together so that when cam 16 is rotated about pivot point 17, elements 10 and 11 are clamped between first member 13 and second member 14, as shown in FIG. 5E.

Coupler 12 may further comprise a marker to indicate when the rod 15 is in the correct orientation for clamping by rotation of the cam 16. For example, there may be a marker on the first member 13 to indicate the desired location of the lever 18. Alternatively, the rod 15 may be only partially threaded, such that further translation of the second member 14 towards the first member 13 by rotation of the rod 15 is substantially limited once the members 13, 14 are sufficiently close together for clamping by rotation of cam 16 about pivot point 17.

In some embodiments, it may be possible to tighten the coupler by rotation of rod 15 to such an extent that elements 10 and 11 are clamped between first member 13 and second member 14 without requiring rotation of the cam 16 about the pivot point 17. However, it is preferable to close the coupler by rotating the cam 16 about the pivot point 17. Closing the coupler in this way provides a more stable closed clamping position than rotation of the rod 15 alone. A coupler fastened by rotation of the rod 15 alone would be susceptible to being loosened by small knocks to the coupler 12, for example, and could not be as quickly unfastened.

In some embodiments of coupler 12, rotation of rod 15 may be substantially prevented when the coupler is in the closed position. This may substantially prevent the coupler 12 from becoming loose by accidental rotation of rod 15.

An exemplary means to prevent rotation is illustrated in FIG. 6. In this embodiment, coupler 12 further comprises a pin 20 extending outwards from first member 13. When the lever 18 and cam 16 are in the closed position, pin 20 may substantially prevent rotation of the lever that would loosen the coupler 12 by translating the second member 15. In particular, for the right hand screw mechanism illustrated in FIGS. 5B-C, the pin may prevent anti-clockwise rotation of rod 15 when the lever 18 is in the closed position. When the lever 18 is in the open position, however, pin 20 does not prevent rotation of the rod 15.

Other embodiments may use alternative means for preventing rotation of rod 15, for example a saddle to hold the lever 18 in place when in the closed position.

In some embodiments, the coupler 1, 12 may further comprise a resilient means, for example a spring, between the first member 2, 13, and the second member 3, 14.

FIG. 7A illustrates an exemplary embodiment of a coupler 1 further comprising a spring 21 between the first member 2 and second member 3. The spring 21 is configured to oppose translation of the first member 2 towards the second member 3. In the illustrated embodiment, rod 4 passes through the centre of spring 21, but in other embodiments the spring may be located separately from the rod.

When closing the coupler 1 by rotating cam 5 about pivot point 6, spring 21 is compressed, as shown in FIG. 7B. The resistance provided by spring 21 when the coupler is being closed may provide for a smoother closing action. Spring 21 additionally helps keep first member 2 and second member 3 apart prior to location of the coupler 1 on elements 10 and 11.

Any other suitable resilient means may be used, for example a resiliently deformable member. Such a resiliently deformable member may be made from a resilient material such as a compressible rubber. One or more resilient means may be used in conjunction with any embodiment of a coupler according to this invention.

In some embodiments, more than one rod may be used, e.g. to increase and/or better distribute the clamping force of the coupler. FIG. 8 illustrates an alternative embodiment of a coupler 22. Coupler 22 comprises a first member 23 and a second member 24. A first rod 25 passes through the first member 23, and is connected to the second member 24. A second rod 26 passes through the second member 24, and is connected to the first member 23.

A first cam 27 is rotatably attached to the first rod 25 about a pivot point 28. The first cam 27 may be rotated about pivot point 28 by pushing the lever 29. A second cam 31 is rotatably attached to the second rod 32 about a pivot point 33. The second cam 31 may be rotated about pivot point 32 by pushing the lever 33. In alternative embodiments, both rods 25, 26 may pass through the first member 23 and be attached to the second member 24.

In the illustrated embodiment, the first rod 25 and second rod 26 are attached to the second member 24 and first member 23 respectively by fasteners 30, 34. However, any of the rods or means for attachment described in relation to the other embodiments of the invention may be used with coupler 22. The first rod 25 and second rod 26 may also be attached to the same (first or second) member.

In use, coupler 22 may be placed over elements 10 and 11, and clamped by rotation of cams 28 and 31. Using two sets of rods and cams may increase and/or better distribute the force with which elements 10 and 11 are clamped together.

In the illustrated embodiment, elements 10 and 11 are located in use between rods 25 and 26. In alternative embodiments, the rods 25, 26 may be located, for example between the elements 10, 11.

As described above, a coupler 1, 12 , 22 may be initially located around the elements 10, 11 by placing the coupler 1, 12, 22 over the top of the elements 10, 11 and sliding the coupler 1, 12, 22 to its desired location for coupling. FIG. 9 illustrates an alternative method of initially placing a coupler 1 around elements 10, 11. In this method, the second member 3 is rotated around rod 4 by approximately 90° relative to the first member 2. Second member 3 may then be passed between the elements 10 and 11, as shown in FIG. 9. The second member 3 may be subsequently rotated around rod 4 to be substantially oriented in line with first member 2, and the coupler fastened as described above. This method may be applied to any embodiment of the couplers described according to this invention.

One or more parts of the coupler 1, 12, 22 may be formed substantially of high density plastic. Branding may be applied to the coupler, in particular to discourage theft of loaned parts, or the couplers may carry individual product numbers to allow stock levels to be more easily monitored. The coupler 1, 12, 22 may be marked or coloured to indicate a purpose associated with it. When used to connect two temporary fence panels, for example, the coupler 1, 12, 22 may be coloured to indicate an emergency access route that can be created by releasing the coupler and parting the fence panels. For example, a red coupler may indicate a potential access route in the event of a fire; a yellow coupler may indicate a potential access route for medical emergencies; and an orange coupler may indicate a potential access channel for public evacuation.

A single coupler 1, 12, 22 may be used to connect together two elements 10, 11. Alternatively, multiple couplers may be used to coupler elements 10 and 11 together. For instance, multiple couplers could be used to join together a pair of elongate elements such as poles, posts or the like, at a plurality of points along the lengths of the multiple elements.

As discussed above, one or more rapid assemble couplers 1, 12, 22 may be used to connect two fence panels together, typically to provide a temporary fence or barrier. For some uses of a temporary fence, particularly security fences intended to form a physical barrier, it may not be desirable for people on one side of a fence to be able to quickly release the coupler 1, 12, 22. In these situations, the coupler 1, 12, 22 may be located on the fence uprights so as to prevent the coupler 1, 12, 22 being opened from one side of the fence. For example, the coupler 1, 12, 22 may be located sufficiently higher than the bottom of the fence panels, and/or sufficiently lower than the top of the fence panels, to prevent people from the other side reaching the lever of the coupler 1, 12, 22 without crawling under or climbing over the fence panel.

In some embodiments, the coupler 1, 12, 22 may be operable to be attached to a backstay. These embodiments may be particularly useful when the coupler 1, 12, 22 is used to connect two adjacent fence panels. A backstay may be used to increase the stability of the fence, e.g. temporary fence, especially on uneven ground or in windy conditions. In particular, in some embodiments the cam and lever may be operable to be removed, and a backstay attached to the rod. For example, the cam and lever may be attached to a threaded portion of the rod, and may be unscrewed from the rod.

FIGS. 10A, 10B and 11 illustrate another example embodiment of a coupler 100 for coupling together two non-overlapping elements 10 and 11. Coupler 100 is similar to coupler 1, except that coupler 100 comprises a wedge 106 rather than a lever operated cam 5.

Coupler 100 comprises a first member 102 and a second member 103. Any of the examples of the first and second members described above may apply equally to first member 101 and second member 102. A rod 104 passes through the first member 102, and is connected at one end to the second member 103, similarly to rod 4 described above. The other end of the rod comprises a stopper 105. A wedge 106 is partially located between the first member 102 and the stopper 105. In the illustrated embodiment, as is best shown in FIG. 11, wedge 106 comprises a slot 107. The rod 104 passes through slot 107.

In FIG. 10A the coupler 100 is shown in an open position. The wedge 106 is pushed out to its furthest possible extent, so that only the thinnest part of the wedge is between the first member 102 and the fastener 105.

FIG. 10B shows the coupler 100 in the closed position, clamping the elements 10 and 11. To close coupler 100 the wedge 106 is translated so that a thicker part of the wedge 106 is located between the fastener 105 and first member 102 than in the open position. The fastener 105 is fixed on rod 104, so translating the wedge 105 forces the first member 102 to move towards the second member 103, thus clamping the elements 110 and 111 between the members 102, 103. For example, the wedge may be pushed with an operator's hand, or may be hit with a hammer.

Any of the examples described above in relation to couplers 1, 12, or 22, insofar as they do not relate specifically to the lever-operated cam, may equally apply to coupler 100. For example, coupler 100 may further comprise a resilient biasing member, such as a spring, between the first member 102 and second member 103.

The wedge may be configured such that the translation required to open and close the coupler may be at least partially linear or non-linear.

The wedge may have any suitable shape.

For instance, the wedge may not be straight and may comprise one or more corners. The wedge may be curved at least in part. In an embodiment, the wedge may have the form of part of a spiral, such that the coupler can be closed and opened by rotating the wedge.

The wedge may have a uniform or non-uniform gradient.

FIG. 12 illustrates another example embodiment of a coupler 120 for coupling together two non-overlapping elements 10 and 11. Coupler 120 comprises a first member 122 and a second member 123. A rod 124 passes through the first member 122, and is connected at one end to the second member 123, similarly to rod 4 described above. Coupler 120 further comprises a resilient biasing means 125 between the first member and second member, such as a spring. In the illustrated example, rod 124 passes through resilient biasing means 105, similarly to the example of coupler 1 shown in FIG. 7A.

Coupler 120 further comprises a threaded fastener 126 adapted to engage with a threaded portion 107 of the rod 105. The threaded fastener may for example be a wingnut or a nut. In use, coupler 120 may be placed around elements 10 and 11, similarly to the examples of couplers described above. The first member 122 and second member 123 are pushed together, so that the elements 10 and 11 are clamped between the members 122, 123. The threaded fastener is screwed onto and along the threaded portion 127 or rod 124, until it is adjacent to the first member 122. The threaded fastener cannot pass through the first member 122, and so prevents the first member 122 from moving away from the second member 123.

In a similar example, the fastener 126 may be attached to the first member 122, or may be integrated into the first member 122. Instead of rotating the fastener 126 to lock the first and second members 122, 123 in place, in this example the rod 124 may be rotated so that its threaded portion 127 engages with the fastener 126. In particular, the rod may be rotated so that the fastener 126, and hence the first member 122, are drawn towards the second member 123, thus clamping the elements 10, 11 between the members 122, 123. For example, one end of the rod 124 may comprise a slotted screw head, into which a screwdriver may be inserted and used to rotate the rod 124.

Any of the examples described above in relation to couplers 1, 12, or 22, insofar as they do not relate specifically to the lever-operated cam, may equally apply to coupler 100.

FIGS. 13A and 13B illustrate another example of a coupler 130 for coupling together two non-overlapping elements 10 and 11. Coupler 130 comprises a first member 132 and a second member 133. Coupler 130 further comprises a notched rod 134. Notched rod 134 comprises a plurality of notches 135. Notched rod 134 is pivotably coupled to the second member 133. In the illustrated example, the second member 133 comprises a second rod 136, to which the notched rod 134 is pivotably attached at pivot point 137.

FIG. 13A shows the coupler 130 in an open position. The rod 134 passes through a hole 139 (shown in FIG. 13B) in the first member 132, but the notches of the rod 134 are not engaged with any part of the first member 132.

FIG. 13B shows the coupler 130 in a closed position, clamping elements 10 and 11 together. The first member 132 and second member 133 are pushed together so that the elements 10, 11 are clamped between the members 132, 133. The notched rod 134 is pivoted about point 137, and one of the plurality of notches 135 is engaged with a notch 138 on the first member 132, locking the first member 132 and second member 133 in place around elements 10 and 11. In FIG. 13B the broken lines represent parts of the components inside the hole 139 in first member 132 through which the rod 134 passes.

Any of the examples described above in relation to couplers 1, 12, or 22, insofar as they do not relate specifically to the lever-operated cam, may equally apply to coupler 130. For example, coupler 130 may further comprise a resilient member, such as a spring, between the first member 132 and second member 133.

Although the embodiments discussed above have described coupling two elements together, it is to be understood that any embodiment could be adapted to coupler three or more elements together. In particular, at least one surface of the first face and second face may be adapted to conform to the shape of the three or more elements.

Other embodiments are intentionally within the scope of the invention as defined by the appended claims.

1. A rapid assemble coupler for coupling together at least two non-overlapping elements, the coupler comprising:
a first member and an opposing second member;
a rod passing through the first member and connected in use to the second member; and
a cam pivotably attached to the rod;
wherein, in use, rotation of the cam causes the first member to be translated towards the second member, thereby clamping each element between the first and second member.

2. The coupler of claim 1, wherein:
i) the cam is a lever-operated cam, and optionally, wherein the cam is integrated into the lever; or
ii) the cam comprises a handle for rotating the cam.

3. (canceled)

4. (canceled)

5. A rapid assemble coupler for coupling together at least two non-overlapping elements, the coupler comprising:
a first member and an opposing second member;
a rod passing through the first member, the rod comprising a first end connected in use to the second member and a second end comprising a stopper; and
a wedge at least partially located between the first member and the stopper;
wherein, in use, translation of the wedge in a first direction causes the first member to be translated towards the second member in a second direction that is substantially perpendicular to the first direction, thereby clamping each element between the first member and the second member.

6. The coupler of claim 5, wherein the wedge comprises a slot, and wherein the rod passes through the slot.

7. The coupler of claim 1, wherein, in use, the rod passes between the two elements.

8. The coupler of claim 1, wherein at least one surface of the first member and/or the second member is adapted to conform to the shape of the at least two elements.

9. The coupler of claim 1, wherein the rod has a threaded portion passing through the second member, and wherein rotation of the rod causes the second member to be translated axially relative to the rod, and optionally wherein the coupler further comprises a means operable to substantially prevent rotation of the rod in a direction that would cause the second member to be translated away from the first member.

10. (canceled)

11. The coupler of claim 1, wherein the rod is connected to the second member by means of a fastener that is external to the second member, and optionally wherein:
i) the fastener is a bolt and/or
ii) the fastener is permanently attached to the second member.

12. (canceled)

13. (canceled)

14. The coupler of claim 1, further comprising at least one resilient means between the first member and the second member, the or each resilient means being configured to oppose translation of the first member towards the second member, and optionally wherein the resilient means comprises a spring, and further optionally wherein the rod passes through the spring.

15. (canceled)

16. (canceled)

17. The coupler of claim 1, wherein the first member, the second member the cam or the lever are formed from high density plastic.

18. The coupler of claim 1, further comprising:
a second rod passing through the first member and connected, in use, to the second member; and
a second lever-operated cam pivotably attached to the second rod;
wherein, in use, rotation of the second cam causes the first member to be translated towards the second member, thereby clamping the elements between the first and second member; and
optionally wherein in use the elements are located between the first and the second rod.

19. The coupler of claim 1, further comprising:
a second rod passing through the second member and connected in use to the first member; and
a second lever-operated cam pivotably attached to the second rod;
wherein in use rotation of the second cam causes the second member to be translated towards the first member, thereby clamping the elements between the first and second member; and
optionally wherein in use the elements are located between the first and the second rod.

20. (canceled)

21. The coupler of claim 3, further comprising:
a second rod passing through the first member, the rod comprising a first end connected in use to the second member and a second end comprising a second stopper; and
a second wedge at least partially located between the second member and the second stopper;
wherein, in use, translation of the second wedge in a third direction causes the second member to be translated towards the first member in a fourth direction that is substantially perpendicular to the third direction, thereby clamping each element between the first and second member.

22. The coupler of claim 1, wherein the coupler is operable to be attached to a backstay.

23. A fence comprising:
a rapid assemble coupler according to claim 1; and
at least two fence panels, each fence panel comprising one of the said elements;
wherein the rapid assemble coupler couples the elements of the two fence panels together.

24. A scaffold pole assembly comprising:
at least two scaffold poles; and
a rapid assemble coupler according to claim 1;
wherein the rapid assemble coupler couples two scaffold poles together.

25-28. (canceled)

29. A rapid assemble coupler for coupling together at least two non-overlapping elements, the coupler comprising:
a first member and an opposing second member; and
a rod pivotably connected to the second member, the rod comprising a plurality of notches adapted to engage with a reciprocal notch on the first member.

30. The coupler of claim 29, further comprising at least one resilient means between the first member and the second member, the each resilient means being configured to oppose translation of the first member towards the second member.

31-33. (canceled)
